(19) United States
(12) Patent Application Publication
(10) Pub. No.: US 2012/0078585 A1
(43) Pub. Date: Mar. 29, 2012

(54) METHOD AND SYSTEM FOR CONSTRUCTING GEOMETRIC SKELETONS AND MEDIAL ZONES OF RIGID AND NON-RIGID SHAPES

(75) Inventors: Horea Ilies, Glastonbury, CT (US); Ata A. Eftekharian, Austin, TX (US)

(73) Assignee: UNIVERSITY OF CONNECTICUT

(21) Appl. No.: 13/172,824

(22) Filed: Jun. 29, 2011

Related U.S. Application Data
(60) Provisional application No. 61/398,643, filed on Jun. 29, 2010.

(51) Int. Cl. G06F 17/50

(52) U.S. Cl. 703/1

(57) ABSTRACT

A method and system for constructing geometric skeletons of rigid and non-rigid shapes are disclosed, including a method of constructing a convexized skeleton (C-skeleton). A method for determining a medial zone, and its practical applications, are also disclosed.

### CROSS-REFERENCE TO RELATED APPLICATIONS

This application claims the benefit of U.S. Provisional Application No. 61/398,643, filed on Jun. 29, 2010, which is incorporated by reference herein.

### STATEMENT REGARDING FEDERALLY SPONSORED RESEARCH

The present disclosure was developed in part with funding from the National Science Foundation under Grant # 0644769. The United States Government has certain rights in this invention.

### BACKGROUND OF THE DISCLOSURE

1. Field of Disclosure

The present disclosure relates generally to systems and methods for geometry-intensive design and analytical applications.

2. Description of Related Art

Shape skeletons are fundamental concepts for describing the shape of geometric objects, and have found a variety of applications in a number of areas where geometry plays an important role. Two types of skeletons commonly used in geometric computations are the straight skeleton of a (linear) polygon, and the medial axis (MA) of a bounded set of points in the k-dimensional Euclidean space.

Medial axis is an important tool in computational geometry and geometric modeling. The concept of medial axis has been described with the help of a fire grass analogy as follows: if a fire starts from all points of a planar curve at the same time, and moves with constant velocities in all directions in the same plane, then the medial axis is the locus of points where the fire (a moving front) meets itself. Extending the concept to k-dimensional geometric shapes in [symbol] R^{k}, the medial axis becomes a set of dimension k−1. The points on the medial axis are equally distant to at least two points of the curve. A shape and its medial axis are connected in the same way regardless of the dimension of the space (i.e., they are homotopy equivalent), which is a feature exploited in many applications, including those that focus on shape similarity.

Closely related to the medial axis of a point set is the concept of a straight skeleton. In 2-D, the straight skeleton of a polygon consists of line segments obtained from trimming the bisectors of the polygon edges, which can lead to ambiguous constructions. The straight skeleton partitions an n-gon into n polygons that contain only one of the edges of the original polygon.

The straight skeleton and the medial axis are identical for convex polygons, but are different for non-convex polygons. Both the straight skeleton and the medial axis are uniquely defined for a given shape, and induce a disjoint partitioning of the shape.

To further describe shape skeletons in general, a useful analogy is the skeletal structure of extinct animals. Their organic skeletons contain sufficient information that can be used by anthropologists to reconstruct the image of the living creatures that were once supported by these skeletons, and from which facts can be inferred about the individual and collective behavior of these extinct creatures. In the same way, shape skeletons can be used to capture critical information about the shapes to which they correspond. In addition, such shape skeletons support a variety of geometric applications while having a lower dimension than the shape itself, thereby leading to faster computations. The great promise of shape skeletons is that they can greatly simplify complex geometric reasoning tasks.

However, computation of these skeletons, even for fairly simple shapes, remains a continuing problem.

Current technologies for the application of shape skeletons compute the medial axis for simple shapes—mostly 2-dimensional (2-D), piecewise linear boundaries, i.e., polygons or polyhedra—by following fundamentally different algorithms. A couple of published algorithms that work in 3-dimensional space (3-D) are exclusively for rigid polyhedral shapes that have planar surfaces.

Geometric skeletons are fundamental concepts in practically all geometrically intensive areas of science and engineering, such as automated finite element meshing, shape manipulation, recognition and comparison, dimensional reduction in design and analysis, robotic surgery, and a variety of path and motion planning in commercial and defense applications. More recently, skeletons have been used to explore the fundamental geometric problems of folding and unfolding related to some of the important problems in science today, such as protein folding and sheet metal bending.

Though widely used in engineering, computer graphics, and computer vision, the underlying algorithms used to compute shape skeletons are still restricted to fairly simple and static shapes. By contrast, many practical applications, such as motion planning of unmanned autonomous vehicles (UAV), must operate in environments that are not completely known, or in environments that are evolving in time.

The popularity of the medial axis in shape modeling and analysis comes from several well-known properties. For example, a medial axis captures the connectivity of the domain, has a lower dimension than the space itself, and is closely related to the distance function constructed over the same domain.

Geometric skeletons can be used to synthesize, analyze and reason about geometry in practically all applications that use and operate with 3-dimensional geometry. However, there remains a need for improved approaches for exact computation of these skeletons of even fairly simple planar shapes.

### SUMMARY OF THE DISCLOSURE

The present disclosure provides a method to define and compute a shape skeleton, as well as define and compute classes of such skeletons.

The present disclosure further provides computation of shape skeletons in more situations than was previously possible to provide new approaches to geometry-based problems.

The present disclosure still further provides shape skeletons that can be used in practically every application or operation that relies on geometric models, including: finite element analysis; path planning and navigation of manned or unmanned (autonomous) vehicles; design and analysis of mechanical systems; design for assembly, mechanical assembly planning; automatic fixture design; feature detection and simplification of geometric models; computer-aided surgery; character and object recognition; and reverse engineering.

The present disclosure yet further provides systems and methods with the ability to handle an evolving environment in which obstacles can appear and/or disappear, merge or split with other obstacles, or merge and/or split with the boundaries of the environment itself. Mathematically, this means that the topology of such evolving environments is changing continuously and drastically.

The present disclosure provides methods that can handle problems in which the environment is not fully known a priori, and the methods intrinsically support local and parallel skeleton computations for domains with rigid or evolving boundaries. The methods of the present invention extend to, and can be applied to, 3-D domains.

The present disclosure also provides implementing path planning algorithms in any commercial geometric kernel, and the algorithms have advantageous computational properties. The capability of the proposed technique is exemplified in the examples described below, which are designed to resemble highly dynamic environments.

The present disclosure still further provides a medial zone of an n-dimensional semi-analytic domain Ω that subsumes the medial axis MA(Ω) of the same domain as a special case, and can be thought of as a “thick” skeleton having the same dimension as that of Ω. The medial zone MZ(Ω) of Ω converges to either MA(Ω) or Ω itself, and is homeomorphic to the domain.

In addition, the present disclosure provides efficient computational paradigms for 2- or 3-dimensional semi-analytic sets with rigid or evolving boundaries. Because the medial zones fuse some of the critical geometric and topological properties of both the domain itself and of its medial axis, re-formulating problems in terms of medial zones affords the “best of both worlds” in applications such as robotic and autonomous navigation, and design automation.

Still further, the present disclosure provides a novel approach to shape optimization that exploits the geometric and topological properties of medial zones and a new shape modification paradigm to synthesize shapes with topological guarantees.

### BRIEF DESCRIPTION OF THE DRAWINGS

FIG. 1A and FIG. 1B illustrate the straight skeleton and the medial axis, respectively, of a planar polygon.

FIG. 2, subparts (a)-(c), illustrates three implicit representations of the polygonal domain in FIGS. 1A/1B that correspond to (a) α=0; (b) α=0.5; and (c) α=1, respectively.

FIG. 3 illustrates an indexing procedure for a sample polygon and its edge indices that is used to identify concavities.

FIG. 4A and FIG. 4B illustrate a distance function and a zero level set for an R-function, respectively.

FIG. 5A, FIG. 5B, and FIG. 5C illustrate the straight skeleton of a non-convex domain that contains all ridges and ravines of the R-function, the C-skeleton that contains only the convex edges (ridges) of the R-function, and the corresponding medial axis of the domain, respectively.

FIG. 6 illustrates additional halfspaces that are required to construct exact distance functions for concave polygons, including: subpart (a) that is the conic section obtained by intersecting halfspace ƒⱼ with the boundary of conical halfspace added at the convex vertex vᵢ; subpart (b) that illustrates the bisector between a point and a line obtained by projecting the conic section onto the plane of the domain; and subpart (c) that illustrates trimming the bisector by introducing additional halfspaces hᵢ¹ and hᵢ² normal to the two incident edges eᵢ and eᵢ₊₁ at vertex vᵢ.

FIG. 7 illustrates polygonal domains with one curved boundary segment and their corresponding C-skeletons and medial axes, where subparts (a) and (c) show C-skeletons, and subparts (b) and (d) show medial axes.

FIG. 8 illustrates a C-skeleton and medial axis (subparts (a) and (b), respectively) of a simple non-convex polygon, as well as the corresponding approximate and exact distance functions (subparts (c) and (d), respectively).

FIG. 9 illustrates a C-skeleton and medial axis (in subparts (a) and (b), respectively), of a planar domain with holes.

FIG. 10 illustrates adaptation of the medial axis to topological changes of the boundary of Ω, where subpart (d) illustrates a final domain that is a non-manifold disconnected planar domain.

FIG. 11A and FIG. 11B illustrate the medial axis and C-skeleton, respectively, for a sample polygon with one curved segment.

FIG. 12 illustrates a planar domain bounded by NURBS curves, C-skeleton, and medial axis (subparts (a), (b) and (c), respectively), as well as the corresponding approximate and exact distance functions constructed in a commercial geometric modeler (subparts (d) and (e), respectively).

FIG. 13 illustrates halfspaces that define a polygonal domain with the trimmed conical halfspace added-in (subparts (a) and (b), respectively), along with the corresponding approximate and exact distance function (subparts (c) and (d), respectively).

FIG. 14A illustrates a planar domain Ω, its medial axis, and the shortest path planned along the medial axis between two configurations; FIG. 14B illustrates the same planar domain with a medial zone (shaded) and the corresponding shortest path for the same two end configurations.

FIG. 15, subparts (a) to (c), illustrates a slice of a distance function with a plane perpendicular to the medial axis, to demonstrate control of the thickness of the medial zone by adjusting values of α and γₘₐₓ.

FIG. 16, subparts (a) to (c), illustrates an evolving, initially-connected, polyhedron whose concave regions grow uniformly, and the medial axis of the final (disconnected) instance of the polyhedron.

FIG. 17, subparts (a) to (d), illustrates a gear solid (a) that interacts with a helical solid to significantly change the solid topology (b).

FIG. 18, subparts (a) to (h), illustrates a: (a) 2-D domain, (b) a 2-D medial axis; (c) 2-D medial zone when α=0.95; (d) 2-D medial zone when α=0.90; and (e) the corresponding 3-D solid object; (f) 3-D medial surface; (g) 3-D medial zone when α=0.95; and (h) 3-D medial zone when α=0.90.

FIG. 19, subparts (a) to (d), illustrates the 2-D domain presented in FIG. 18 with the planned motion between two prescribed configurations for 3 different values of α.

FIG. 20, subparts (a) to (f), illustrate the use of a medial zone for automating shape synthesis whose size can be adjusted by controlling the values of α and γₘₐₓ.

### DETAILED DESCRIPTION OF THE DISCLOSURE

Motion planning is ubiquitous in many geometric intensive applications involving moving objects such as robotics, virtual reality, computer-aided design and manufacturing, computer-aided surgery, computational biology and many others. Motion planning usually ignores differential constraints, and focuses primarily on the translations and rotations required to move an object from an initial configuration to a final position and orientation. One of the most useful and common abstractions of this general problem is to transform the motion planning of an object in the Euclidean space into the path planning of a point in the configuration space (“C-space”) of the object.

An exemplary embodiment of a method of the present disclosure for path planning relies on a powerful medial axis computation paradigm employing constructive representations of shapes based on R-functions. An exemplary embodiment of the method includes:
determining (i.e., constructing) an exact implicit distance function over a planar domain bounded by arbitrarily complex (semi-analytic) boundary curve segments. The output of this step is a Boolean logic expression that implicitly defines the environment in which the object moves. The zero-level set of this function is the boundary of the free space itself, and the Boolean nature of the formulation allows one to: (1) easily add/remove obstacles of arbitrary complexity into/from the environment at any time during or after the initial planning, and (2) handle drastic topological changes of the environment such as merging and splitting of the obstacle or of the environment itself;
obtaining a medial axis;
extracting a skeleton of the medial axis formed by those points of the planar domain where the distance function is non-differentiable; and
determining an explicit mapping between each segment of the medial axis and the subset of the boundary of the domain to generate the particular medial axis segment, where this step has an output that is the medial axis segment.

The method may further include the step of generating collision-free paths for a moving point/object by employing a graph search expression or algorithm.

The present disclosure provides methods and formulations to account for such evolutions in the environment while maintaining the ability to compute shape skeletons.

The methods of the present disclosure remain valid and reliable for arbitrarily complex geometry, which represents a major improvement over the state of the art.

The present disclosure provides foundational methods necessary to compute both 2-dimensional (2-D) and 3-dimensional (3-D) shape skeletons. This success in computing skeletons of 3-D shapes provides advantages for industrial applications such as those identified elsewhere in this specification.

The present disclosure further provides a novel paradigm for constructing and computing families of geometric skeletons that are capable of addressing not only polyhedral shapes, but also the most general shapes. Apart from the present disclosure, there is no other known method or system for constructing such geometric skeletons for non-polyhedral shapes.

The geometric models of the present disclosure do not have to be rigid but, rather, can evolve over time. This feature is critical, for example, in unmanned autonomous vehicle (UAV) path planning, where the environment changes as new information becomes available, or in computer-aided surgery where the shapes are non-rigid.

The present disclosure provides methods and systems that are capable of constructing geometric skeletons for deformable and evolving shapes.

The present disclosure further provides computation methods related to medial zones that can be thought of as “thick” skeletons. Such methods provide enormous advantages for path planning.

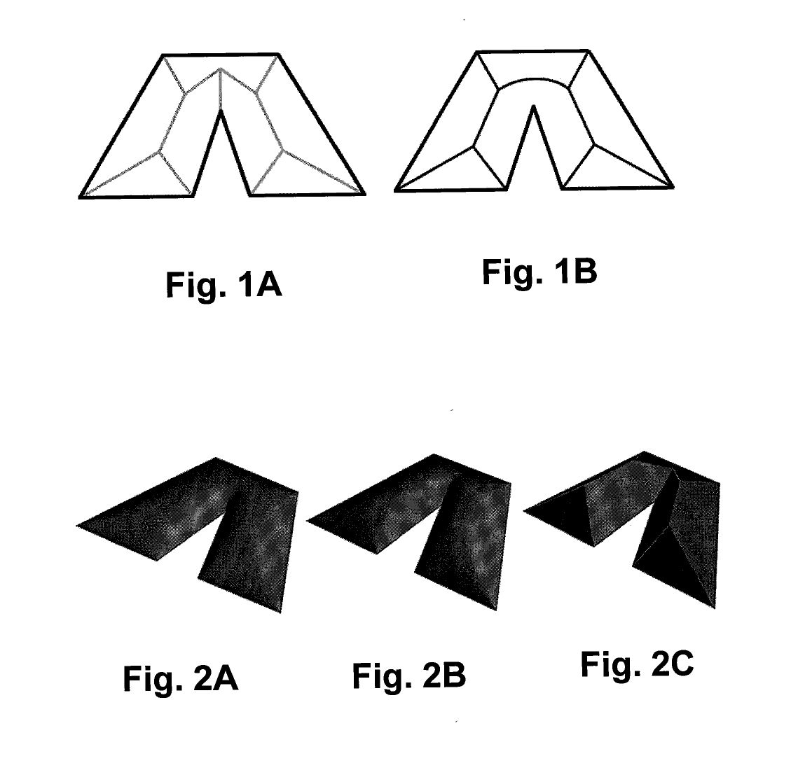

The present disclosure provides a method and a system for constructing and computing families of geometric skeletons, including medial axis, straight skeleton, and the C-skeleton (described more fully herein), as well as the corresponding radius functions. As an example, the straight skeleton and the medial axis of a planar polygon are provided in FIG. 1A and FIG. 1B, respectively.

A further feature of the method of the present disclosure is the ability to handle problems in which the environment (in which an object is moving) is not fully known a priori, because obstacles can be introduced and/or removed at any time during the planning stage and within the same problem formulation.

Still another feature of the method of the present disclosure is intrinsic support of local and parallel skeleton computations for domains with rigid or evolving boundaries due to explicit mapping between the branches of the medial axis and the halfspaces bounding the environment.

The methods of the present disclosure can be implemented in any commercial geometric kernel because halfspaces (designated as hᵢ) become surfaces in the 3-D space, and these surfaces can be combined according to the describing R-function.

The methods of the present disclosure handle trajectory planning of points, as well as path planning for planar objects within the same formulation due to the close relationship between R-functions and level sets. For example, the simplest approach to extend the trajectory planning to 2-D objects is to approximate the moving object by its smallest enclosing ball, and take a different level set of the R-function defining the environment. This effectively offsets the boundary of the environment so that the outer boundaries of the environment shrink while, at the same time, the obstacles grow by the same radius of the disk enclosing the object. A better approximation for translating objects can be obtained by using the well-known Minkowski operations.

The present disclosure supports multiple representations of input geometry such as curves defined implicitly or parametrically.

The method and system of the present disclosure extend to applications involving 3-D domains. Such extensions require additional halfspaces beyond the trimmed conical halfspaces that are necessary and sufficient for 2-D applications. Moreover, the R-functions defining 3-D environments would be 4-dimensional (4-D) entities. In some embodiments related to 3-D domains, the disclosed method may no longer be able to rely on commercial geometric kernels for constructing the distance function and for extracting the skeleton; instead, discrete edge-based detection expressions are employed to extract non-differentiable points of the corresponding implicit distance function.

The methods of the present disclosure include steps of computing constructive representations of shapes with R-functions that operate on real-valued halfspaces as logic operations, that can handle 3-D polyhedra (and the most general class) of 3-D shapes, i.e., semi-analytic sets.

In contrast to the present disclosure, the known technologies in the art compute the medial axis for simple shapes (mostly 2-D, piecewise linear boundaries—i.e., polygons or polyhedra) by following fundamentally different algorithms and methods.

The skeletons of the present disclosure can be used in practically every application or operation that relies on geometric models. Some examples of areas where the present disclosure can be applied include: finite element analysis; path planning and navigation of manned or unmanned (autonomous) vehicles; design and analysis of mechanical systems; design for assembly, mechanical assembly planning; automatic fixture design; feature detection and simplification of geometric models; computer-aided surgery; character and object recognition; and reverse engineering.

Shape optimization (with topological changes) has become a de facto standard approach for synthesizing new designs. Current approaches rely heavily on voxelized modifications of the initial domain, followed by heuristic reconstruction procedures that result in a detailed shape design. The initial domain is almost always conservatively estimated so that the design space spans a sufficiently large set of possible solutions.

The medial zone is a “thick skeleton” of the domain induced by prescribed boundary conditions. The medial zones produce an initial solution that is topologically valid. This initial solution is modified by adding or subtracting material, for example, defined via prescribed shape functions. This approach has many advantages in terms of topological guarantees, shape control, and computational costs. The approach also supports parametric optimization of freeform geometry, can be implemented in any geometric representation that supports distance computations, and subsumes most other shape optimization approaches.

The present disclosure further provides a framework for constructing exact or approximate distance functions and the associated skeletons for solid semi-analytic sets that can be either rigid or undergoing topological deformations. Shapes are defined constructively with R-functions that operate on real-valued halfspaces as logic operations. The present methods are able to construct skeletons for any semi-analytic set, even with evolving boundaries and/or ongoing topographical changes.

More specifically, the present disclosure provides that the approximate distance functions induce a new type of skeleton, which is called the “C-skeleton,” which is piecewise linear for polygons, and generalizes naturally to planar and spatial domains with curved boundaries.

In addition, the present disclosure provides that the introduction of additional halfspaces in the same formulation provides the exact distance function and the medial axis of any semi-analytic planar set, as well as the corresponding radius function. The present formulation completely avoids performing trimming and pruning of the computed skeletons.

The following is an exemplary embodiment of a framework for computing skeletal representations of a semi-analytic domain Ω.

For any closed subset Ω of [symbol] ^{k}, i.e., a set that contains its boundary points, the distance from a point P (where Pε [symbol] ^{k}) to the boundary of Ω is usually defined as in equation (1) below:

d(P)=inf∥P−x∥, (xε∂Ω) (1)

Consequently, every continuous function ƒ(P)=0 that is a subset of [symbol] ^{k}, which further implies that one can construct a C^{∞} function that vanishes on the boundary ∂Ω of Ω. Such shapes are in fact semi-analytic sets of points that can be constructed as a finite Boolean combination of real analytic functions ƒᵢ≧0. In other words, one can construct a Cⁿ function over a semi-analytic subset Ω of [symbol] ^{k} by subdividing the boundary of Ω in primitive halfspaces ƒᵢ, followed by a combination of ƒᵢ into a single predicate using the standard Boolean logic operators AND, OR or NOT.

R-functions, which are defined below, provide the means to construct a Cⁿ function over a domain defined by primitive halfspaces. In the context of this application, the R-functions replace the logical operators by real-valued functions, which generate an implicit representation for any semi-analytic set Ω. The R-functions permit construction of approximate and exact distance functions over a semi-analytic domain.

One such R-function, known as the R₁(Δ) system, can be generalized to what is called the principal system of R-functions shown below as Equation (2):

R_{α}(Δ): 1/(1+α) (x₁+x₂±√(x₁²+x₂²−2αx₁x₂)) (2)

where (+) corresponds to the R-disjunction (x₁ Λ_{α}x₂) and (−) corresponds to R-conjunction (x₁ V_{α} x₂). By varying the value of α, different systems of R-functions are obtained. In particular, by setting α=1 in Eq. (2), the R₁(Δ) system of R-functions is obtained, while a value of α=0 in Eq. (2) results in the R₀(Δ) system. These implicit functions are positive inside the domain, negative outside and zero on the boundary. This is illustrated in FIGS. 2A-2C by the three implicit representations of the polygonal domain that correspond to (a) α=0; (b) α=0.5; and (c) α=1, respectively.

Of note, when the expression under the square root in Eq. (2) becomes zero, the R-functions become non-differentiable. Since the medial axis of a semi-analytic domain corresponds to the points where the distance function is non-differentiable, the present method and system seek those points of the R-function in Eq. (2) where the expression under the square root vanishes (i.e., is zero).

With reference again to FIGS. 2A-2C, a difference is shown between the implicit functions constructed over a polygonal domain with the R_{α}(Δ) system for three values of α. It can be seen that for α≠1, the resulting functions are differentiable (except at the origin). On the other hand, the implicit function corresponding to R₁(Δ) shown in FIG. 2(c) is made of piecewise planar patches that intersect at piecewise linear edges. In fact, by projecting the edges of the R-function surface on the plane of the polygon, the present disclosure generates a skeleton of the polygon.

In order to construct a Boolean set representation of a polygonal domain, another exemplary embodiment of the method and system of the present disclosure uses a simple expression based on the Convex Deficiency Tree, which treats each polygon as its convex hull minus a finite number of concavities. Since the polygon is a closed set, the subtraction of concavities must necessarily be regularized (i.e., requiring regularized Boolean operations).

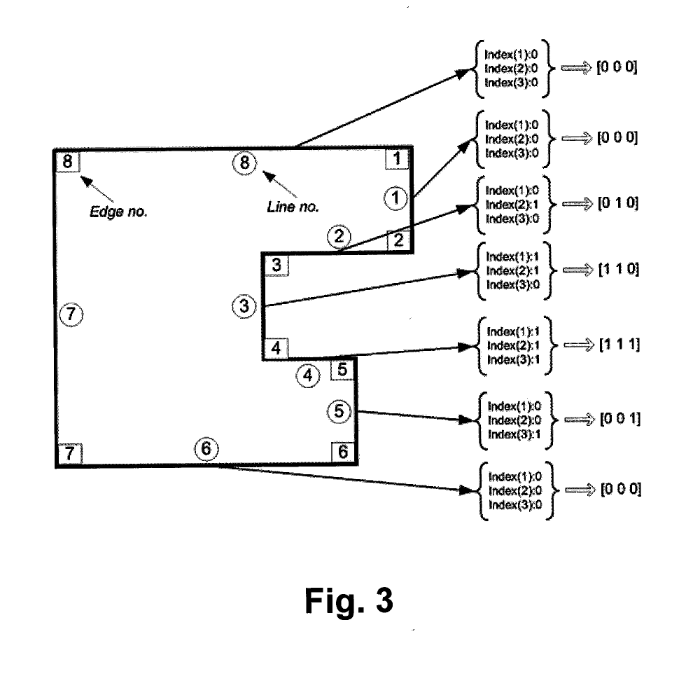

In one embodiment, three binary indices can be used for each individual linear halfspace ƒᵢ, i=1, n, of the polygonal domain that may have concavity regions, as shown in FIG. 3. The orientation of each vector defining an edge is inferred from the order in which the polygon is prescribed by the user. The cross-product is used while progressing in a clockwise orientation around the polygon boundary to determine whether the current edge is: (1) a concave edge (edges (2), (3) and (4) in FIG. 3), or a convex edge (edges (1) and (5)-(8) in FIG. 3). Edges that belong to the latter category may or may not be a part of the convex hull of the polygon. The present method and system differentiate between convex edges that are on the convex hull of the polygon and those that are not. FIG. 3 illustrates the indexing procedure for an arbitrary polygonal domain, where the user initializes the process with convex edge (1).

The edge classification system is used to construct an implicit function (halfspace) corresponding to each edge, such that each halfspace will be positive towards the interior of the polygon. Since the method seeks to establish a distance function for the polygonal domain, the boundary of the 3-D halfspace defined by each linear segment of the polygon's boundary must make an angle of 45° with the plane containing the polygon. If this condition is satisfied, the value of the function ƒᵢ(x) at a point xε [symbol] ² will be equal to the shortest Euclidean distance between x and the line in [symbol] ² that generates the halfspace ƒᵢ.

Constructing the Boolean expression defining the R-function for the polygon relies on the indices summarized above to decompose the polygonal domain into polygonal subchains meeting at vertices that are on the convex hull of the polygon. If two halfspaces (or two subchains) of the original polygon meet at a concave vertex they are combined by set union; otherwise, they are combined by set intersection. Finally, a syntactic substation replaces the union and intersection with the R-disjunction and R-conjunction in Eq. (2), which results in an R-function whose zero level set is the original polygon.

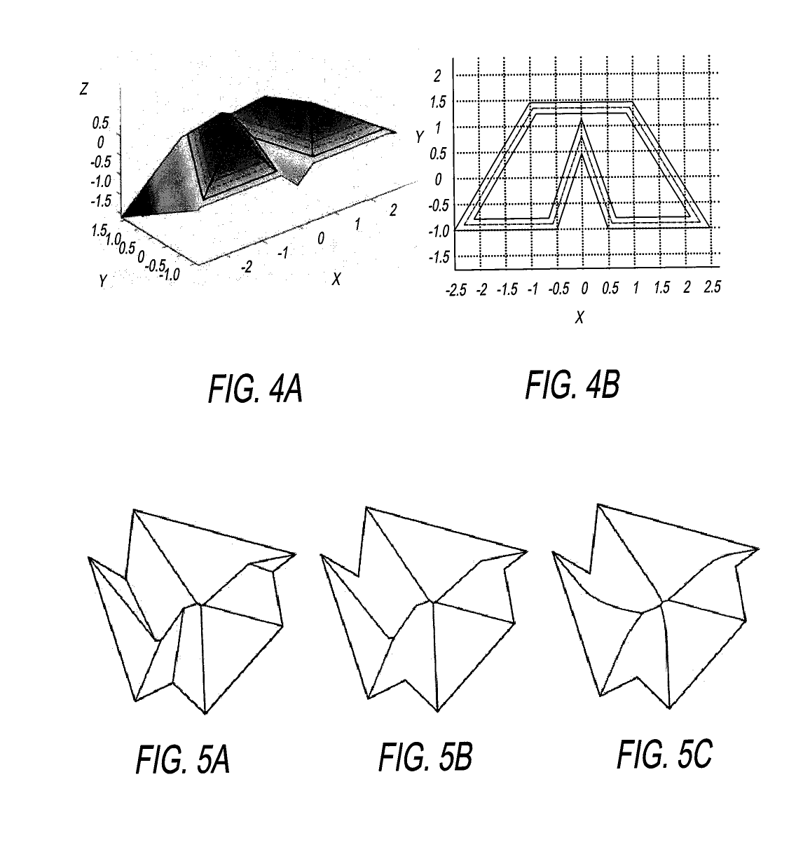

In this manner, an R-function is obtained that is the exact distance function for any convex polygon, and an approximate distance function for a concave polygon, as illustrated in FIG. 4. Such a distance function is obtained from the principal system of R-functions in Eq. (2) by setting the value of α=1, i.e., the R₁(Δ) system.

Referring again to FIG. 4, the distance function computed based on the above procedure has a roof-like structure whose edges are convex (ridges) or concave (ravines). The projection of the edges of this R-function on the plane of the polygon is the set of points that is a straight skeleton. Therefore, to compute the straight skeleton, one needs to extract the edges of the R-function, and then project them onto the plane of the polygon. Several approaches may be used for the “edge extraction” step. One approach is to use a solid geometric kernel to construct and combine the halfplanes. However, this approach cannot be generalized to 3-D domains when the R-function exists in a 4-D space.

Another approach—one that is generalizable to 3-D domains and 4-D R-functions—takes advantage of the fact that the resulting R₁(Δ) R-function is not differentiable at the edges. In order to extract these edges, established techniques for edge detection in computer vision can be used that seek intensity changes in images. Thee techniques rely on the fact that an intensity change in an image is accompanied by a large (or peak) first directional derivative, which is equivalent to a zero-crossing in the second directional derivative of the intensity function captured by the Laplace operator. A finite-difference approximation of the Laplacian shown as equation (3):

∇²ƒ(x, y)≈Iᵢⱼ=ƒᵢ₊₁ⱼ+ƒᵢ₋₁ⱼ+ƒᵢⱼ₊₁+ƒᵢⱼ₋₁−4ƒᵢⱼ (3)

and a line sweep algorithm can be used to identify points in the interior of the polygon where the R-function is not differentiable.

Referring now to FIG. 5(a), the straight skeleton contains the projections of both convex and concave edges of the R-function. If, instead, only the points obtained from projecting the ridges of the R-function are collected, a subset of this straight skeleton is obtained (shown in FIG. 5(b)), that closely resembles the medial axis of the same domain, which is shown in FIG. 5(c). This skeleton is called a “convexized skeleton,” or “C-skeleton” for short.

Thus, “C-skeleton” is defined as follows in this application: If Ω is a closed, bounded and regular subset of the Euclidean space [symbol] ², the C-skeleton of Ω is the projection of the convex edges of the R-function onto the plane of the domain.

There are multiple approaches to detect the convexity of the edges of the R-function. The discrete Laplacian of Eq. (3) changes its sign between points that are on ridges of the R-function and points that are on its ravines. If all points of the domain are collected for which the discrete Laplacian of Eq. (3) are non-zero, then the straight skeleton of the domain is obtained. On the other hand, if the points of the domain are collected for which the discrete Laplacian of the R-function is negative, the C-skeleton is obtained.

There is a striking similarity between the C-skeleton and the medial axis of the domain shown in FIG. 5. The C-skeleton has the same number of junction (i.e., non-differentiable) points as the straight skeleton of the same domain, and the same number of branches as the medial axis. However, the C-skeleton of polygons is always piecewise linear, so it has a lower geometric complexity than the corresponding medial axis.

For convex polygons, the C-skeleton is identical to the medial axis, but this is not true for all arbitrary polygons. Specifically, in the neighborhood of a concave vertex, the medial axis contains curved segments that are subsets of the bisector of a point and a line. This bisector of a point and a line is known to be a parabola which, by definition, is the set of points equally spaced between the point and the line. In order to obtain these bisectors in the same space as the original planar domain Ω, additional halfspaces must be added to the R-function formulation that would generate the correct bisectors. If appropriate additional halfspaces can be generated, trimmed, and added automatically to the R-function defining the domain Ω such that the new R-function corresponds to an exact distance function for Ω, then their intersection curves (ridges and ravines of their R-function) in [symbol] ^{k+1} Euclidean space will generate the medial axis of Ω by projection onto [symbol] ^{k}.

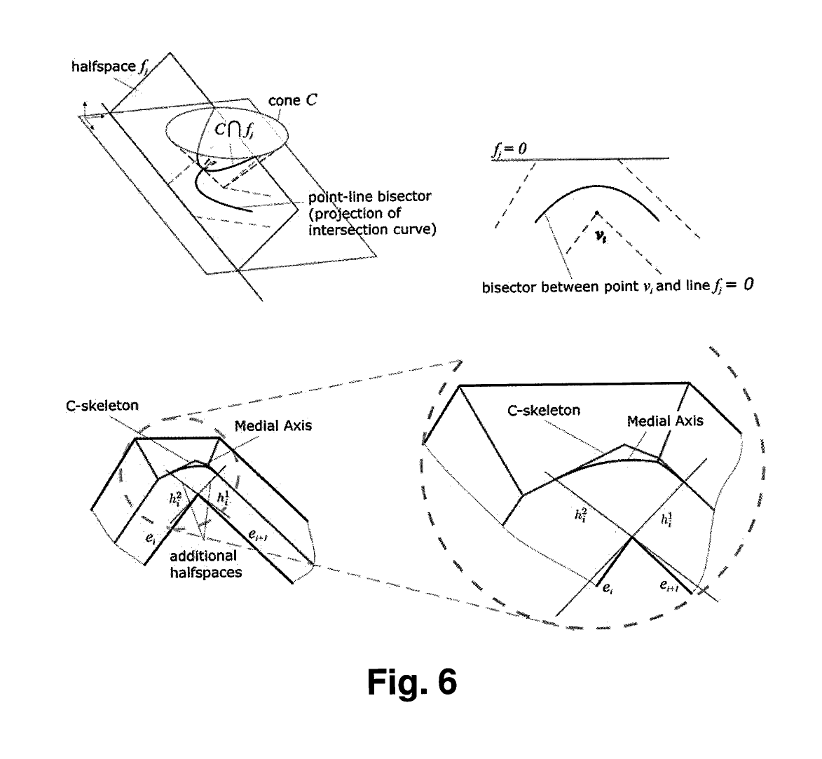

A 3-D view of this procedure is illustrated in FIG. 6(a). The parabolic bisector between a point and the line can be obtained by adding at the concave vertex vᵢ a 3-D conical surface cᵢ whose opening angle is π/2. By intersecting this conical surface with the distance function to a given line (which is a planar halfspace ƒⱼ>0 in 3-D, a conical section is obtained. Its projection onto the plane of the polygon is the bisector between the point P and the line ƒⱼ=0, as shown in FIG. 6(b). This implies that in order to construct the exact distance function of an arbitrary polygonal domain, an additional conical halfspace cᵢ needs to be added at every concave vertex vᵢ of the polygon. However, a simple addition of these conical halfspaces is not sufficient because the corresponding intersection curves need to be trimmed at points that will generate, by projection, the junction points of the medial axis, as illustrated in FIG. 6(c). This trimming process is performed by adding two additional planar halfspaces hᵢ¹ and hᵢ² for each conical halfspace cᵢ such that the two additional halfspaces are normal to the two incident edges eᵢ and e₁₊₁ at vertex vᵢ, or hᵢ¹⊥eᵢ and hᵢ²⊥eᵢ₊₁. In fact, the addition of a conical halfspace at every concave vertex vᵢ of a planar domain (not necessarily polygonal) and of two planar halfspaces that are normal to the two edges incident at vᵢ are not only necessary, but also sufficient for constructing the exact distance function of the domain bounded by halfspaces ƒⱼ.

A planar domain may have one or more holes. In some embodiments, obstacles in the environment can be represented as holes of the domain. An advantage of the present approach to compute skeletons based on R-functions is that holes can be easily added to Ω by simply adding (closed) Jordan curves (i.e., curves in 2-D or s8urfaces in 3-D satisfying the Jordan-Brouwer separation theorem) corresponding to the boundary of each hole. Additional conical halfspaces are added for the vertices of the polygon defining the hole by following the procedure described above. The only difference is where these additional halfspaces are added: a concave vertex of the polygonal domain Ω. The R-function expression corresponding to the hole is subtracted from the R-function defining the outer boundary of Ω with the R-conjunction in equation (4):

ƒ₁Λ₁ƒ₂=½(ƒ₁+ƒ₂−√(ƒ₁²+ƒ₂²−2ƒ₁ƒ₂)) (4)

The connection between R-functions and level sets becomes apparent if one observes that the domain defining the R-function is the zero level set of the R-function itself, as was illustrated in FIG. 4. Level set methods are known to have the ability to track evolving boundaries with and without topological changes. Furthermore, moving boundaries of Ω can be handled easily, although some deformations may require reconsidering the additional halfspaces that need to be added at convex vertices that become concave during deformation. One alternative is to add conical halfspaces at all vertices (both convex and concave); in other words, to introduce redundancy into the R-function itself, because these extra halfspaces will not play any role in the R-function until the corresponding vertex becomes concave.

For domains with curved boundaries, two difficulties in adding curved boundary segments to the polygonal domain are: (1) to construct the distance function corresponding to each curved halfspace; and (2) to add additional halfspaces to the formulation that would generate the point-curve bisectors.

The problem with constructing distance functions to given curves and surfaces arises in many applications. The problem can be reformulated as a numerical search for the foot-point of a curve or a surface, but the search can be slow, does not always converge, and may not be robust. In contrast, the embodiments of the present method and system employ a different strategy; rather than searching for the point(s) on a curve that is (are) closest to a given point of the plane in which the curve lies, the following steps are taken:
(1) enumerating points P_{C} on the curve;
(2) determining/constructing a vector n_{P} normal to the curve at each point P_{C} on the curve that is coplanar with the curve itself;
(3) enumerating points P′_{C} along the line defined by the normal vector n_{P}; and
(4) setting the known distance from P′_{C} to P_{C} as the value of the distance function being sought, that is:

ƒ(x, y)=d(P_{C} to P_{C}).

This procedure has the advantages of being general, in the sense that it remains valid for any semi-analytic halfspace. The procedure also offers the advantages of enumerating values of the distance function without requiring a search, avoiding problems associated with foot-point computations, and being conceptually equivalent to a line that sweeps a halfspace as point P_{C} travels along the planar curve.

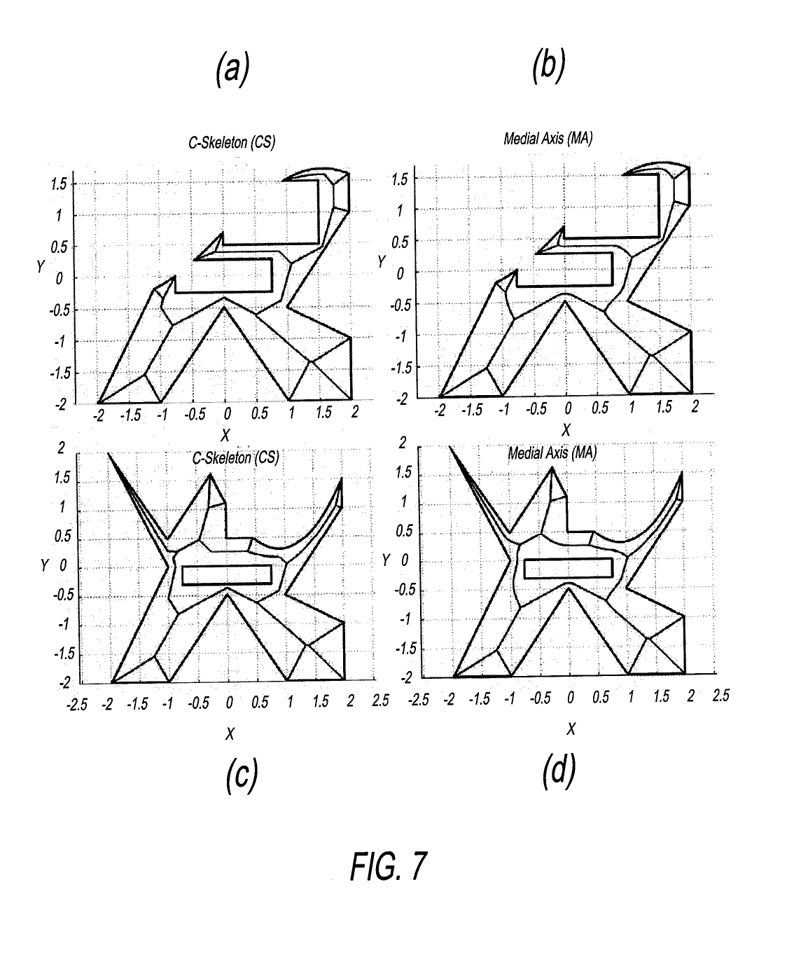

FIG. 7 illustrates two polygonal domains with one curved boundary segment, along with their corresponding C-skeletons and medial axes constructed with the procedures outlined above. Specifically, FIG. 7(a) and FIG. 7(c) illustrate the C-skeletons, and FIG. 7(b) and FIG. 7(d) illustrate the medial axes, for two simple polygons with one curved boundary segment defined by sin x+0.7−y=0 (for (a) and (b)); and (x−0.9)²+0.2−y=0 (for (c) and (d)).

Adding a conical halfspace c, at every concave vertex vᵢ and two halfspaces hᵢ¹ and hᵢ² that are normal to the two incident edges at vᵢ is sufficient to generate the bisector of a point and any planar curve defined by ƒⱼ. A salient feature of this embodiment of the present method is that curve-curve bisectors are embedded automatically in the R-function construction, and no additional halfspaces are required.

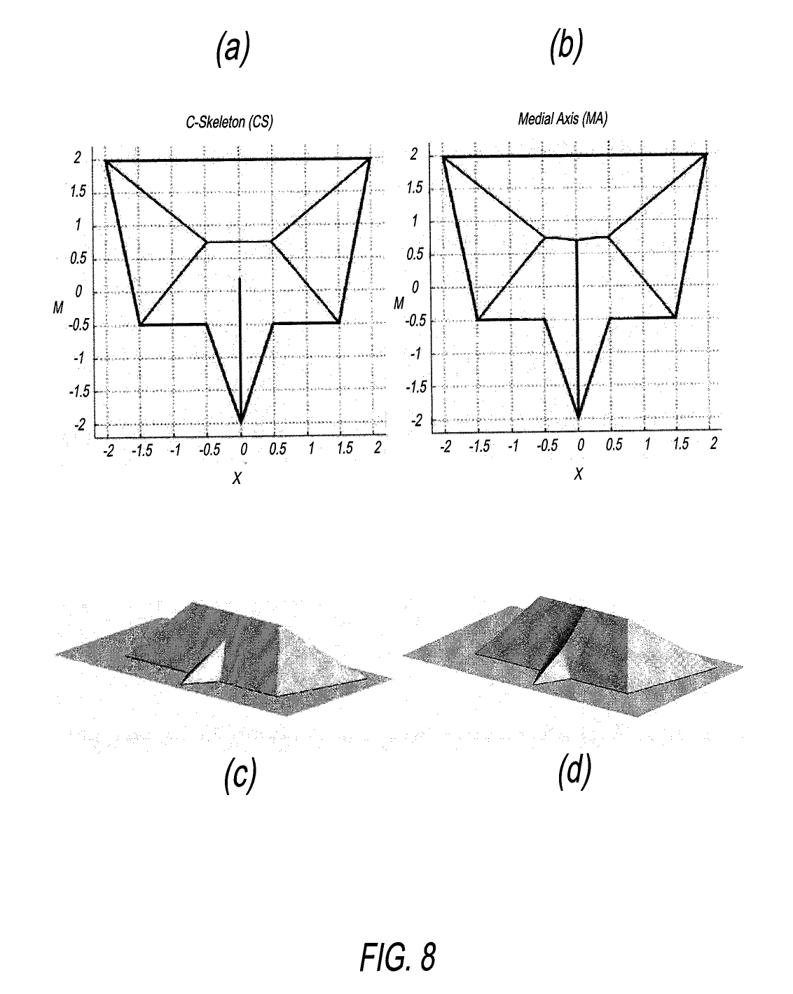

The medial axis has the same connectivity as that of the domain defining the medial axis; however, this is not true for a C-skeleton, which can be a disconnected set even if Ω is simply connected. More specifically, the medial axis and the C-skeleton are identical for convex polygonal domains, and therefore the C-skeleton of a convex polygon has the same connectivity as its convex domain. However, for non-convex domains, the medial axis and the C-skeleton are different, and the C-skeleton may or may not be a connected set, depending on the geometry and relative positions of the halfspaces defining Ω, even if Ω is simply connected. An example is provided in FIG. 8, which shows (a) a C-skeleton and (b) the medial axis of a simple non-convex polygon, along with the corresponding (c) approximate and (d) exact distance functions. However, the disconnected C-skeleton becomes a connected medial axis by introducing the additional halfspaces at the concave vertices, by the processes described above.

The instability of the medial axis with respect to the Hausdorff distance (i.e., small changes in the boundary of Ω may induce large changes in the MA(Ω)), and may require a pruning step (essentially heuristic) when computing the medial axis of a noisy point sample. A benefit of the topological property of the C-skeleton described above is that the disconnected C-skeleton of a noisy point sample can be used to prune the approximated medial axis when the domain Ω is approximated by a finite point set. For the case shown in FIG. 8, if the coordinates in the bottom-most point reflect the “noise” in the data, the vertical segment of the medial axis would be pruned.

### Examples

The following examples display the capabilities of exemplary embodiments of the present method and system.

Distance functions can be constructed within a solid geometric kernel to construct and combine the halfspaces according to a Constructive Solid Geometry (CSG) expression defining the R-function. This, in turn, provides the boundary of the solid bounded by the R-function and the plane of the planar domain, as well as a parametric representation of all the trimmed curve segments comprising the ridges and ravines of the R-function. A disadvantage of this approach is that it does not generalize to 3-D domains when the R-function exists in a 4-D space.

Alternatively, the R-functions can be constructed programmatically, followed by an edge detection process, and by projection of all or some of these edges onto the space of the domain, as described above. This numerical procedure can be followed by a fairly simple segmentation of these points to identify the halfspaces that generate a particular point of the skeleton, where this segmentation amounts to repeated function evaluations, as well as by a reconstruction step to fit piecewise polynomial curves (and surfaces in 3-D) to the segmented point sets.

All numerical results provided in the following examples were obtained by implementing the described approach in Matlab, while the last example was constructed in Unigraphics.

### Example 1

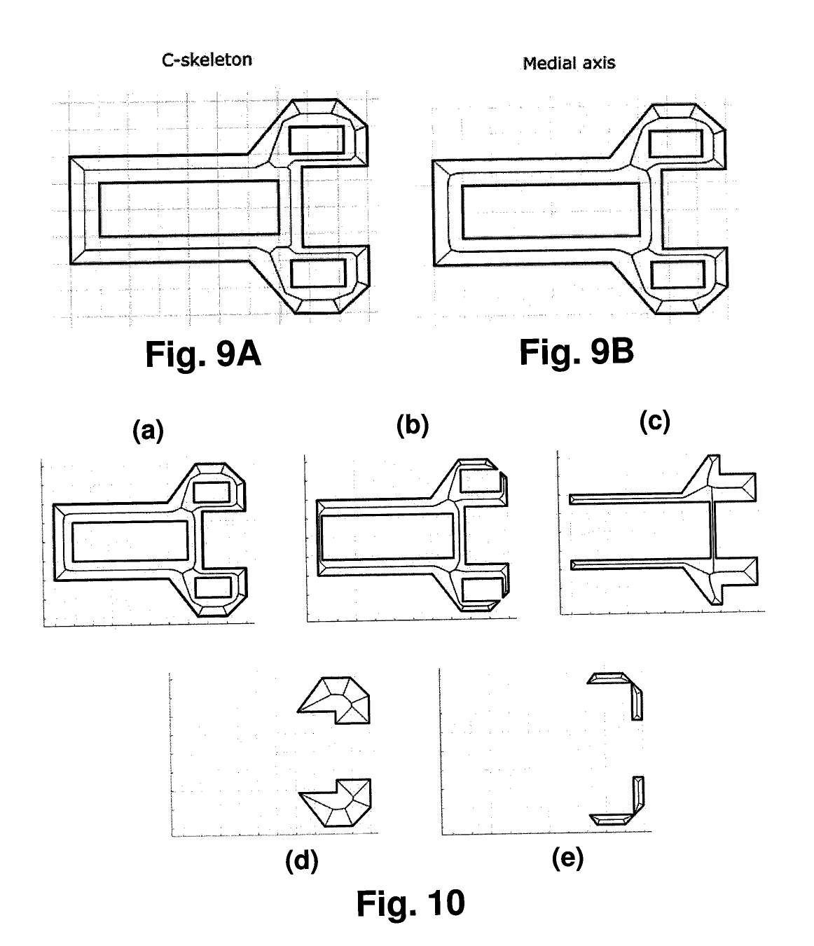

The first example shows a non-convex wrench-like polygonal domain with 14 edges and 3 holes. By definition, the C-skeleton of such a domain must only contain straight line segments, but the medial axis will contain both linear and parabolic curve segments. The Boolean expression is computed in four steps by constructing one R-function for the polygon itself, and three separate R-functions for the three holes. These four R-functions are then combined with the appropriate Boolean operators. Finally, ridges are detected and projected to the x-yY plane to obtain the C-skeleton. Converting the C-skeleton into the medial axis requires addition of conical halfspaces cᵢ and trimming halfspaces hᵢ to the Boolean set expression, as described above. The computed C-skeleton and medial axis for this example are illustrated in FIG. 9.

### Example 2

In this example, the domain defined in FIG. 9 undergoes topological changes generated by scaling the holes while translating in the positive x direction. The boundary of the holes will collide with the outer boundary of the polygon and with each other, which will generate drastic topological changes, which are shown in FIG. 10. The Boolean expression defining the domain does not change, but the C-skeleton and the medial axis adapt to the topological changes. This shows that the present method can track changes in the skeletons induced by changes in the boundary of the domain within the same formulation even when subjected to severe topological changes. The final domain, which is shown in FIG. 10(d), is a non-manifold disconnected planar domain. Each halfspace affects only a subset of the skeleton. The present approach explicitly provides the correspondence between any particular branch of the skeleton and the halfspaces that generate that particular branch. In principle, this can be employed to develop adaptive computations of the changes induced by transformations of the domain boundary, which could result in local computations of the changes in the skeleton shape induced by local modifications in the boundary of the domain.

### Example 3

A third example illustrates a domain that contains one curved boundary segment and seven holes. Constructing the Boolean set expression of this shape follows essentially the same procedure as described above, except for how the halfspace defined by the curved segment was constructed, which followed the procedure described above, namely:
(1) enumerating points P_{C} on the curve;
(2) constructing a vector n_{P} normal to the curve at each point P_{C} on the curve that is coplanar with the curve itself;
(3) enumerating points P′_{C} along the line defined by the normal vector n_{P}; and
(4) setting the known distance from P′_{C} to P_{C} as the value of the distance function being sought, that is: ƒ(x, y)=d(P′_{C} to P_{C}).

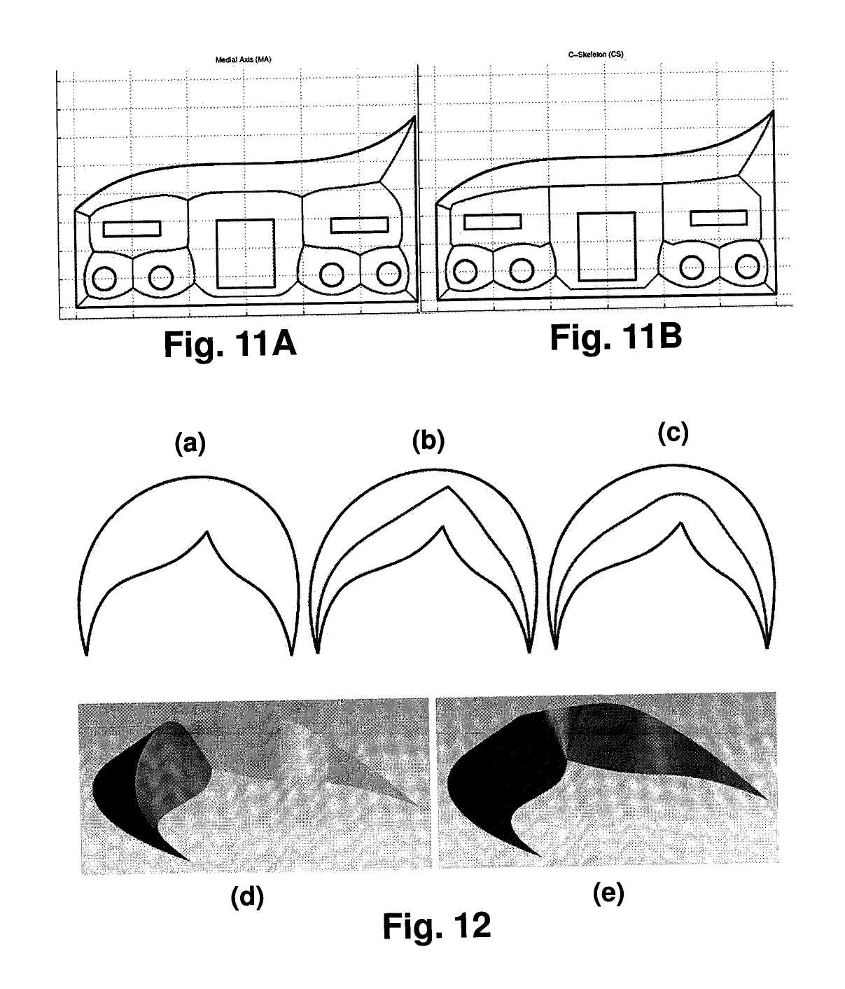

The computed C-skeleton and the medial axis of this domain are shown in FIG. 11. For this example, the curve is defined by ax³+by⁵+c=0, where a, b and c are constants. The medial axis will contain curved bisecting segments, as shown in FIG. 11(a). Unlike previous cases, the curved boundary will introduce curved branches in the C-skeleton. Since the Boolean expression for the C-skeleton will not contain the conical and trimming halfspaces, the corresponding curved segments of the C-skeleton will be different than those of the medial axis.

### Example 4

The fourth example is a planar domain bounded by piecewise cubic polynomial segments, as illustrated in FIG. 12(a). The C-skeleton and the corresponding approximate distance function are shown in FIG. 12(b) and FIG. 12(d). By introducing a conical halfspace as well as two additional trimming halfspaces h₁ and h₂ (not shown) at the concave vertex, the exact distance functions can be determined shown in FIG. 12(e), and the medial axis can be extracted, as shown in FIG. 12(c). In this example, the approximate and exact distance functions have been constructed in Unigraphics based on the R-function predicate. The edges of the distance functions have been obtained by intersecting the halfspaces according to the Boolean expression, and are piecewise polynomial curves. Their projection onto the plane of the domain provides the C-skeleton and medial axis of this domain bounded by NURBS (Non-uniform rational B-spline) curves.

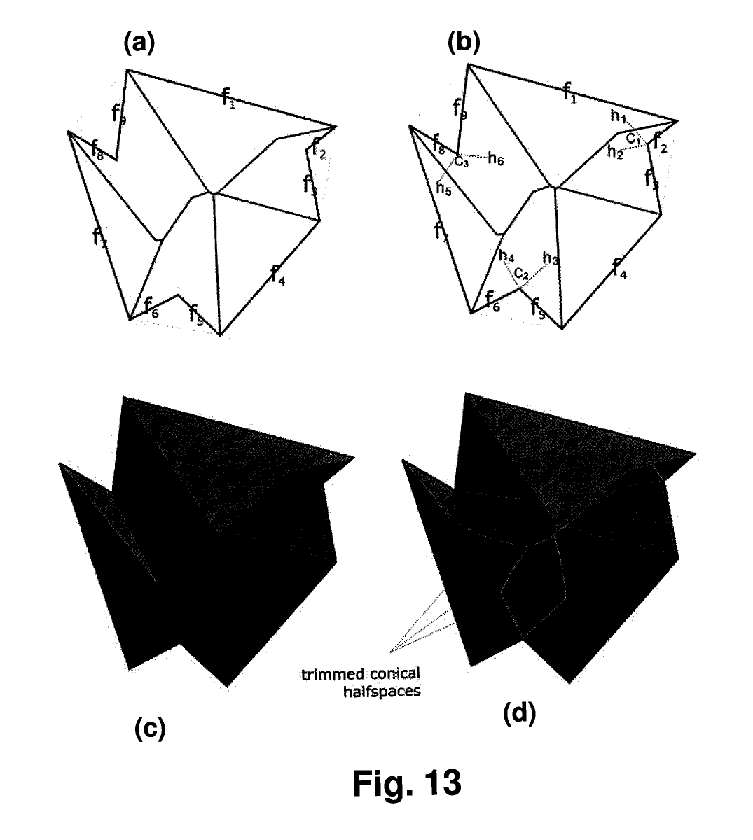

Referring now to FIG. 13, the domain shown is the same as illustrated in FIG. 5, with the assumption that each linear edge is part of a halfspace that represents the exact distance function to the carrier of the line. Specifically, the domain shown in FIG. 13 has three concave vertices. Since each vertex is shared by two incident edges, these can be denoted as:

z₁=(ƒ₂∪ƒ₃) (6)

z₂=(ƒ₅∪ƒ₆) (7)

z₃=(ƒ₈∪ƒ₉) (8)

where the halfspaces defined by the incident edges at each of the three concave vertices, whose positive side points towards the interior of the domain. Therefore, the Boolean expression generating the approximate distance function can be written as:

ƒ(x, y)=(ƒ₁∩ƒ₄∩ƒ₇)∩(z₁∩z₂∩z₃) (9)

The R-function is constructed by forming a syntactic substitution of the Boolean operations with the corresponding R-disjunction and R-conjunction from Eq. (2) above, and the resulting function is illustrated in FIG. 13(c). The ridges of this approximate distance function are projected onto the plane of the polygon to obtain the C-skeleton shown in FIG. 13(a).

The approximate distance function given in Eq. (9) can be converted into an exact distance function by adding trimmed conical halfspaces at the concave vertices as follows:

z₁→z₁∪(h₁∩h₂∩c₁) (10)

z₂→z₂∪(h₃∩h₄∩c₂) (11)

z₃→z₃∪(h₅∩h₆∩c₃)

The effect of these trimmed conical halfspaces on the resulting distance function is illustrated in FIG. 13(d). Therefore, the exact distance function will be given by the same Eq. (9), but with the new halfspaces zᵢ, i=1, 2, 3 that contain the trimmed conical halfspaces. The projection of this exact distance function generates the medial axis shown in FIG. 5(c).

The methods and systems of the present disclosure provide a novel approach to construct either exact or approximate distance functions and the associated skeletal representations for 2-D semi-analytic sets that can be either rigid or undergoing topological deformations. The distance functions are defined constructively based on R-functions that operate on real-valued halfspaces as logic operations. The R-functions can be used to construct approximate distance functions over a domain defined by primitive halfspaces, where the R-functions replace the corresponding logical operations by real-valued functions. In turn, this results in an implicit representation of the approximate distance function for any semi-analytic planar domain.

Furthermore, the constructed approximate distance function corresponds to a new type of skeleton, the C-skeleton, which is piecewise linear for polygons, has attractive properties, and generalizes naturally to planar and spatial domains with curved boundaries. The C-skeleton closely resembles the medial axis of a planar domain, but has a lower geometric complexity, which is an advantage for a variety of applications where medial axis is currently being used.

By adding conical halfspaces and trimming halfspaces at every concave vertex of the domain, the approximate distance function is transformed into an exact distance function. In addition, the medial axis, which corresponds to the ridges of the exact distance function, can be extracted either algebraically (by combining the corresponding halfspaces according to the Boolean expression defined by the R-function as illustrated, for example, in FIG. 12) or numerically.

Several other critical features provide the generality and flexibility that are benefits of the method and system of the present disclosure. Specifically, the proposed C-skeleton is the same as the straight skeleton for convex polygons, but has fewer edges for concave polygons. For piecewise linear shapes, the C-skeleton has the same number of branches as the medial axis, but a lower geometric complexity due to its piecewise linear structure.

Moreover, the construction of the exact distance function and medial axis of a planar domain only requires the addition of a conical halfspace as well as two trimming halfspaces to the Boolean expression defining the approximate distance function for every concave vertex. If these halfspaces are added for every vertex of the domain (both concave and convex), the halfspaces will automatically contribute to the exact distance function and the corresponding medial axis as long as the corresponding vertex is concave, while these halfspaces will have no effect for convex vertices. This is particularly beneficial for domains with evolving boundaries because it eliminates the need to keep track of the convexity of vertices.

Another advantage of the method and system of the present disclosure is that the straight skeleton, C-skeleton, and medial axis of a planar domain can all be generated within the same formulation. Due to its Boolean nature, the same formulation can handle both rigid or deformable domains, possibly undergoing drastic topological changes. This feature becomes particularly useful in those applications where the environment is not fully known a priori, such as adaptive motion planning in dynamic environments.

Still another advantage of the method and system of the present disclosure is that the C-skeleton can be disconnected even if the domain is simply connected. This property of the C-skeleton can, in turn, be used to trim the branches of the medial axis that appear to be due to noise in the data; i.e., the pruning problem.

Yet another advantage of the method and system of the present disclosure is that they support multiple representations of the input geometry, and provide a simple, efficient expression for constructing an implicit representation of a planar curve (and of its associated halfspace) directly from its parametric representation, which could be a practical alternative to the conventional foot-point computations.

In addition, the disclosed method could be implemented in any existing commercial CAD system and geometric kernel that supports freeform surfaces and standard geometric operations on surfaces.

Finally, the method and system disclosed herein extends naturally to 3-D, with the addition of further trimmed halfspaces.

The present disclosure further provides a system for constructing geometric skeletons of a shape. In an embodiment of the system, the system has a determining device that determines a distance function over a planar domain bounded by semi-analytic boundary curve segments. This first determining device has an output that is a Boolean logic expression that defines the environment in which an object moves. The system also has an extracting device that extracts a skeleton of a medial axis formed by points of the planar domain where the distance function is non-differentiable. The system may further have a second determining device that determines a mapping between each segment of the medial axis and a subset of the boundary of a domain to generate a particular medial axis segment. This second determining device has an output that is the particular medial axis segment.

The present disclosure provides a method for determining a “medial zone” of a semi-analytic domain. An embodiment of the method for determining (also referred to as constructing herein) includes determining a distance function over the semi-analytic domain, where the distance function includes an R-function and where the distance function has a distance function surface. The method further includes selecting a value in the R-function that eliminates singular points of the distance function that correspond to interior points of the semi-analytic domain. The medial zone is determined by collecting all points of the semi-analytic domain within an angle that is formed between the normal to the distance function surface and a vector along an axis corresponding to the value of the distance function. The medial zone further subsumes the medial axis. For practical reasons, the medial zone can be restricted to a subset of the semi-analytic domain; however, medial zones exist outside of the domain similarly with the medial axis.

The medial zone and the semi-analytic domain are homeomorphic.

The distance function may include the following steps: enumerating a first set of points on the distance function surface; constructing a vector that is normal to the distance function surface at a selected point on this surface; enumerating a second set of points along the normal vector; and setting the known distance from the second set of points to the selected point as the value of the distance function.

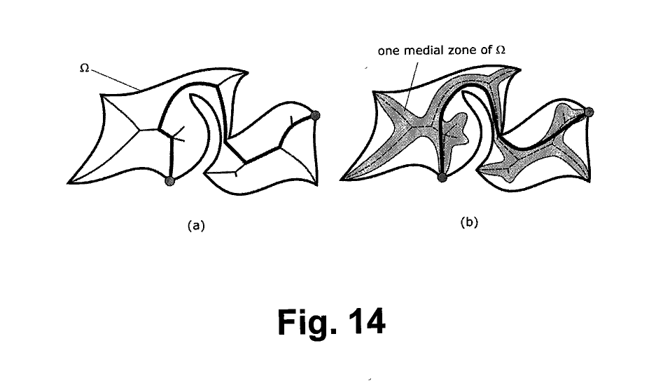

Referring now to FIG. 14A and FIG. 14B, a medial axis (FIG. 14A) and a medial zone (the shaded area in FIG. 14B) are illustrated for the same planar domain Ω. Also illustrated is shortest path between two end configurations along the medial axis (FIG. 14A) and along a subset of the medial zone (FIG. 14B). The path in FIG. 14B (along a subset of the medial zone) is shorter by 13.34%, and visibly smoother, than the path along medial axis in FIG. 14A.

In practical terms, the use of medial zones in path planning applications retains the properties of medial axes in the neighborhood of narrow passages, while resulting in globally shorter paths. Medial zones can also provide a new paradigm to automate the shape synthesis of mechanical artifacts.

As noted above, the medial zone of an n-dimensional semi-analytic domain Ω subsumes the medial axis MA(Ω) as a special case, and can be thought of as a “thick” skeleton having the same dimension as that of Ω.

The medial zone MZ(Ω) can converge to either MA(Ω) or domain Ω itself, and is homeomorphic to the domain.

Distance functions are constructed from individual halfspaces bounding a semi-analytic domain (Ω) and are combined with R-functions into a single distance function over Ω. The R-functions provide the flexibility of constructing exact distance functions over Ω whose ridges and ravines correspond to classes of skeletons of Ω. For example, by projecting the ridges of the exact distance function, one obtains the medial axis MA(Ω). Furthermore, the R-functions can be used to construct approximate distance functions whose crests define the medial zones of Ω.

The R-functions used to construct medial zones are the same equations as described above for other geometric skeletons, such as Eq. (2). When α=1 in Eq. (2), piecewise smooth distance fields are generated and the skeletons are obtained as the non-differentiable points of the distance functions described above. However, one important feature of R-functions is that they can generate continuous and smooth functions over the domain that are differentiable almost everywhere. By simply selecting a value of 0≦α≦1, one eliminates the singular points of the distance function that correspond to interior points of the domain.

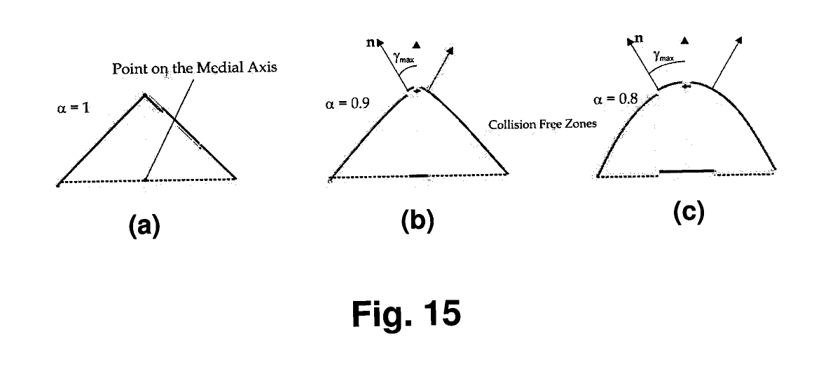

FIG. 15, subparts (a) to (c), illustrates a cross-section of the distance function of a planar domain with a plane perpendicular to the medial axis, and the effect of decreasing the value of α on the shape of the resulting distance function. As α decreases, the resulting function becomes smoother. Furthermore, by controlling the value of the angle γₘₐₓ, which is the angle between the normal to the distance function surface and the axis corresponding to the value of the distance function (as illustrated, the axis is vertical), and by collecting all points of the domain for which γ<γₘₐₓ, a subset medial zone (MZ) is obtained of the domain that contains, by definition, the medial axis of that domain. This subset MZ is, in fact, the medial zone that corresponds to given values of α and γₘₐₓ as shown in the medial zone in FIG. 14B. The smaller the value of α, and the larger the value of γₘₐₓ, the “thicker” the medial zone.

In this description, α is a “global” parameter, while γₘₐₓ is a local parameter defined at a point. In this application, γₘₐₓ is the same at every point in the domain.

Therefore, the medial zone MZ_{α,γmax} of a semi-analytic domain Ω is the set of points:

MZ_{α,γmax}(Ω)={PεΩ)|angle of (n, e_{d}<γₘₐₓ)Λ(0<α<1)}

where n is the normal to the distance function surface, and e_{d} is a vector along the axis corresponding to the distance function value.

### Examples and Applications

In the following examples, a parallelized version of the code that relies on Message Passing Interface (MPI) libraries is used; specifically, MPICH2 implementation on a PC workstation.

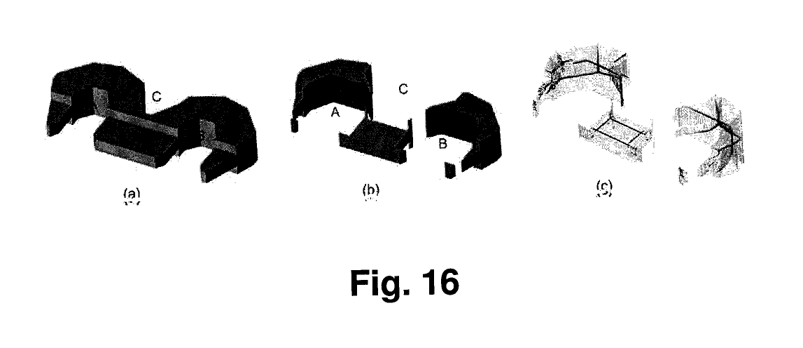

FIG. 16 illustrates an example of a polyhedron undergoing drastic topological changes due to uniform growth of three concave regions in subpart (b). The medial axis of the final instance of the evolving polyhedron is illustrated in subpart (c). As expected, the PCU time linearly decreases with each additional core of the processor used by the parallel algorithm.

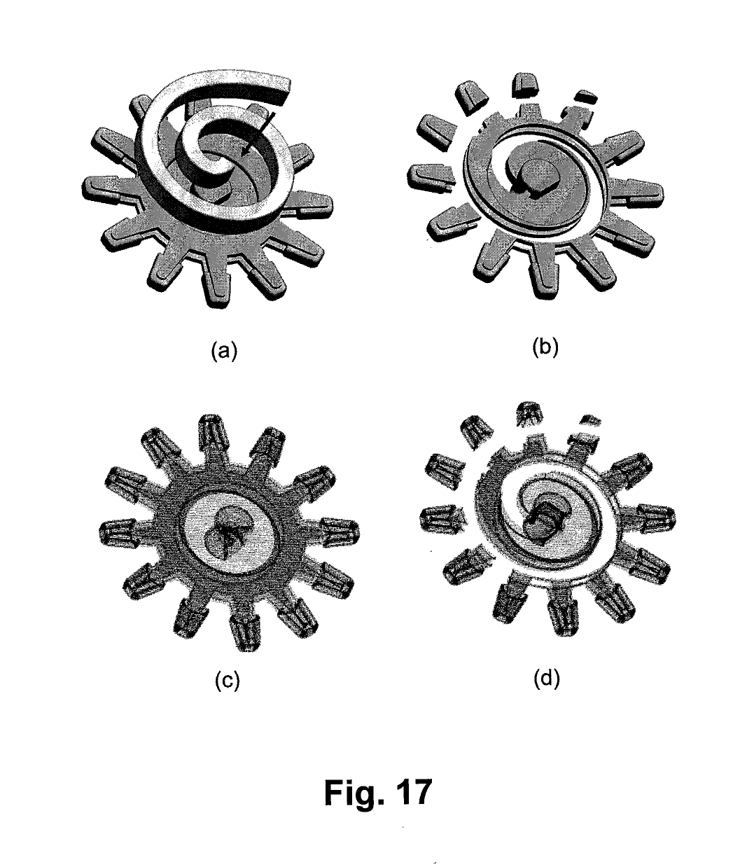

FIG. 17 illustrates the medial axis (in subpart (c)) of the gear-like shape in subpart (a). The gear shape is modified by subtracting a helical shape from the original solid, which, in turn, transforms the connected solid model into a disconnected one, as in subpart (b). The same formulation used to compute the medial axis point of the original gear-like object was used to compute the medial axis of the disconnected set in subpart (d).

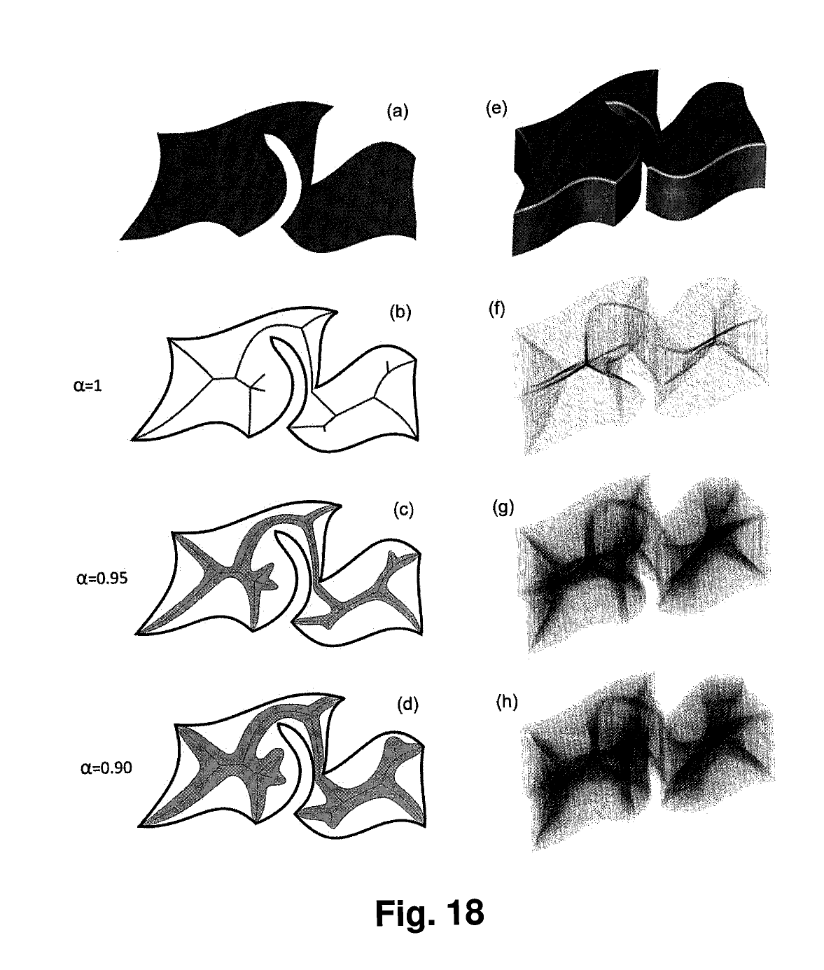

FIG. 18 illustrates the 2-D domain and its 3-D extrusion bounded by both linear and free-form boundaries. The medial axes are shown in subparts (b) and (f), and the medial zones corresponding to different values of α=0.95 and 0.90 are given in subparts (c) and (g) and (d) and (h), respectively.

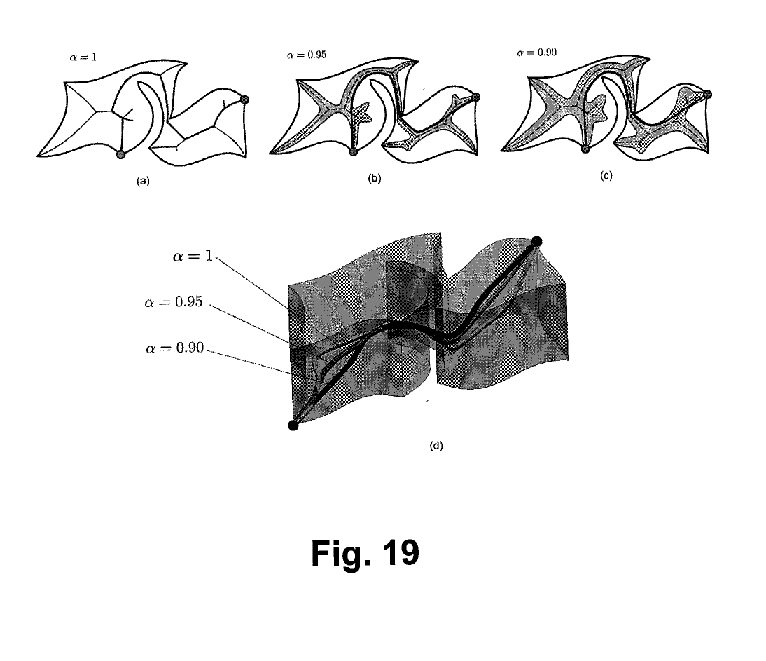

FIG. 19 shows the domain of FIG. 18, its medial axis and an initial and final configuration of the path to be computed. These extreme configurations do not have to be on the medial axis or even on the boundary of the domain.

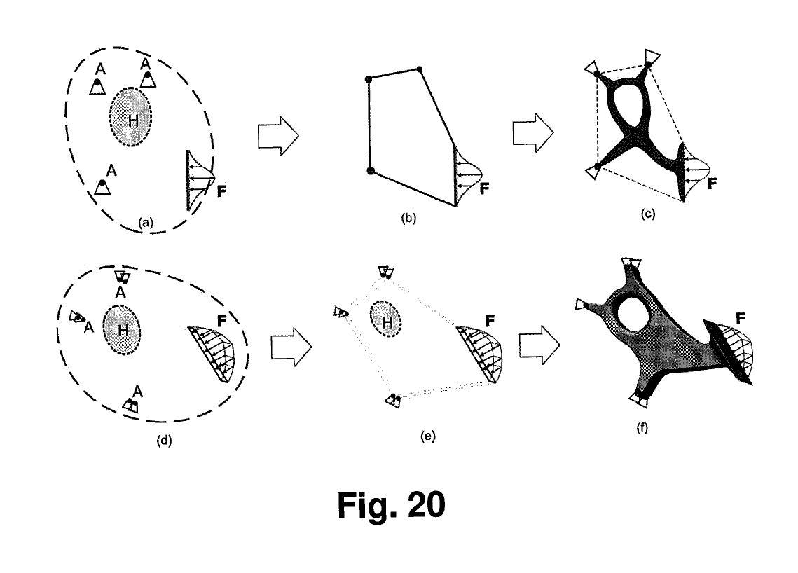

FIG. 20 illustrates the use of a medial zone for automating shape synthesis whose size can be adjusted by controlling the values of α and γₘₐₓ.

As used in this application, medial axis (MA) is defined to mean that, if Ω is a closed, bounded, regular and semi-analytic subset of [symbol] R^{k}, then the medial axis MA(Ω) is the set of points that have at least two closest points in ∂Ω—the boundary of Ω. Thus, MA is the set of all centers of the closed maximal balls, and is a continuous version of the usual Voronoi diagram.

As used in this application, an “R-function” is a real-valued function ƒ(x1, x2, x3, . . . , xn) if its sign is completely determined by the signs of its arguments x. When positive values are interpreted as TRUE and negative values as FALSE, the R-function can operate as a Boolean switching function. In the context of this application, R-functions can replace the logical operations by real-valued functions, which generate an implicit representation for any semi-analytic set Ω. Specifically, these R-functions allow construction of approximate and exact distance functions over a semi-analytic domain.

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances that fall within the scope of the disclosure.

What is claimed is:

1. A method for constructing a geometric skeleton of a shape, comprising:
determining a distance function over a planar domain bounded by semi-analytic boundary curve segments, wherein this first determining step has an output that is a Boolean logic expression that defines an environment in which an object moves;
obtaining a medial axis;
extracting a skeleton of the medial axis formed by a plurality of points of the planar domain where the distance function is non-differentiable; and
determining an explicit mapping between each segment of the medial axis and a subset of the boundary of a domain to generate a particular medial axis segment, wherein this second determining step has an output that is the particular medial axis segment.

2. The method according to claim 1, further comprising:
generating a collision-free path for the moving object by employing a graph search expression after the second determining step.

3. The method according to claim 1, further comprising:
computing the medial axis by employing constructive representations of shapes based on R-functions.

4. The method according to claim 1, wherein the geometric skeleton is a non-rigid shape.

5. The method according to claim 1, wherein the distance function has a zero level set that is the boundary of free space.

6. The method according to claim 1, wherein the Boolean logic expression further comprises adding or removing obstacles of arbitrary complexity to/from the environment at any time.

7. The method according to claim 1, wherein the Boolean logic expression further comprises adapting to topological changes in the environment.

8. The method according to claim 1, further comprising:
modifying the outputs of the first determining step and the second determining step for 3-dimensional domains and environments.

9. The method according to claim 1, wherein the geometric skeletons are employed for an application selected from the group consisting of finite element analysis, path planning and navigation of manned or unmanned autonomous vehicles, design and analysis of mechanical systems, design for assembly, mechanical assembly planning, automatic fixture design, feature detection and simplification of geometric models, computer aided surgery, character and object recognition, and reverse engineering.

10. A system for constructing geometric skeletons of a shape, comprising:
a first determining device that determines a distance function over a planar domain bounded by semi-analytic boundary curve segments, having an output that is a Boolean logic expression that defines the environment in which an object moves; and
an extracting device that extracts a skeleton of a medial axis formed by a plurality of points of the planar domain where the distance function is non-differentiable.

11. The system according to claim 10, further comprising:
a second determining device that determines a mapping between each segment of the medial axis and a subset of the boundary of a domain to generate a particular medial axis segment, wherein the second determining device has an output that is the particular medial axis segment.

12. A method for path planning, comprising:
determining a distance function from halfspaces defining a boundary of an environment in which an object moves;
obtaining a medial axis;
extracting a skeleton of the medial axis as a graph formed by non-differentiable points of the distance function; and
determining a shortest path on the graph.

13. A method for constructing a geometric skeleton of a semi-analytic domain, comprising:
determining an approximate distance function as defined by an R-function over the semi-analytic domain, wherein the R-function has convex edges and concave edges;
extracting the convex edges and concave edges of the R-function;
projecting the extracted convex edges of the R-function onto the surface of the semi-analytic domain to construct the geometric skeleton of the semi-analytic domain that is a convexized skeleton (C-skeleton).

14. The method according to claim 13, wherein the domain is polygonal, and the C-skeleton is piecewise linear.

15. The method according to claim 13, wherein the C-skeleton is employed for an application selected from the group consisting of skeleton-based shape editing and adaptive motion planning.

16. A method for constructing a medial zone of a semi-analytic domain, comprising:
determining a distance function over the semi-analytic domain, wherein the distance function comprises an R-function, and wherein the distance function has a distance function surface;
selecting a value in the R-function that eliminates singular points of the distance function that correspond to interior points of the semi-analytic domain; and
determining a medial zone comprising all points of the semi-analytic domain within an angle formed between the normal to the distance function surface and a vector along an axis corresponding to the value of the distance function, and further comprising a medial axis that corresponds to points where the distance function is non-differentiable,
wherein the medial zone is a subset of the semi-analytic domain.

17. The method according to claim 16, wherein the medial zone and the semi-analytic domain are homeomorphic.

18. The method according to claim 16, wherein determining the distance function further comprises:
enumerating a first set of points on the distance function surface;
constructing a vector that is normal to the distance function surface at a selected point on the distance function surface;
enumerating a second set of points along the normal vector; and
setting the known distance from the second set of points to the selected point as the value of the distance function.

19. The method according to claim 16, wherein the medial zone is employed for an application selected from the group consisting of skeleton-based shape editing, adaptive motion planning, automation of shape synthesis of mechanical artifacts, manufacturing and assembly, robotic and autonomous navigation, and design automation.

20. A method for path planning for navigation, comprising:
determining a subset of points in the medial zone determined in accordance with claim 16 that provides the shortest path between two configurations of the domain.
